(19) United States
(12) Patent Application Publication
(10) Pub. No.: US 2006/0282376 A1
(43) Pub. Date: Dec. 14, 2006

(54) System and method for automated processing of real estate title commitments

(76) Inventors: Peter Lawrence Goldberg, Cleveland Heights, OH (US); Scott Michael Haffner, Strongsville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/413,586

(22) Filed: Apr. 28, 2006

Related U.S. Application Data
(60) Provisional application No. 60/690,773, filed on Jun. 14, 2005.
(60) Provisional application No. 60/737,019, filed on Nov. 15, 2005.
(60) Provisional application No. 60/737,014, filed on Nov. 15, 2005.
(60) Provisional application No. 60/771,910, filed on Feb. 9, 2006.

(51) Int. Cl. G06Q 40/00

(52) U.S. Cl. 705/38

(57) ABSTRACT

Various systems and methods for processing a request for real estate title certification or title commitment, for mortgage application processing, and for obtaining title certification for a real estate loan are provided. The various systems and methods may include a pre-funding pipeline showing the status of pre-conditions to funding a loan. A title commitment may be issued or received separately from a title policy, and responsive to a title commitment being issued or received, the prefunding pipeline may be automatically updated to reflect the title commitment, and loan funding may be permitted after receipt of a title commitment.

### CROSS-REFERENCE TO RELATED APPLICATIONS

This application claims priority to, and any other benefit of, U.S. Patent Application Ser. No. 60/690,773, entitled SYSTEM AND METHOD FOR AUTOMATED PROCESSING OF REAL ESTATE TITLE CERTIFICATIONS and filed Jun. 14, 2005 (attorney docket 30728/04002); U.S. Patent Application Ser. No. 60/737,019 entitled SYSTEM AND METHOD FOR SELF-VALIDATION OF REAL ESTATE LOAN FINDINGS and filed on Nov. 15, 2005 (attorney docket 30728/04005); U.S. Patent Application Ser. No. 60/737,014 entitled SYSTEM AND METHOD FOR AUTOMATED FUNDING OF REAL ESTATE MORTGAGE TRANSACTIONS and filed on Nov. 15, 2005 (attorney docket 30728/04004); and U.S. Patent Application Ser. No. 60/771,910 entitled SYSTEM AND METHOD FOR ELECTRONIC EXECUTION OF REAL ESTATE MORTGAGE LOAN TRANSACTION DOCUMENTS and filed on Feb. 9, 2006 (attorney docket 30728/04003), the complete disclosures of which are hereby incorporated herein by reference in their entireties.

### TECHNICAL FIELD

The described systems and methods are generally related to information processing environments employed to process financial transactions. The described systems and methods may be used to process requests for real estate title certification or title commitment.

### BACKGROUND

For many years, mortgage banks have been in the business of processing residential mortgage loan applications. The processing of each mortgage loan application has traditionally involved a number of activities which have been performed manually and take a considerable amount of time and effort to complete.

While computer technology has enabled mortgage banks to automate certain aspects of the mortgage application review process, the process continues to involve a number of manual tasks including, for example, comparison of expected data to actual data, inter-personal communication between individuals responsible for various portions of the application review process and human oversight over the entire mortgage application process. These manual tasks are inefficient, prone to human error and may become bottlenecks during the mortgage application process.

Consequently, there is a need for methods and systems that address the aforementioned shortcomings of other mortgage loan processing and reporting applications. More specifically, there is a need for improved systems and methods for processing requests for real estate title certification or title certification.

### SUMMARY

The following presents a simplified summary of methods, apparatus, systems, and computer readable media associated with obtaining transaction detail data in accordance with the present application. This summary is not an extensive overview and is not intended to identify key or critical elements of the methods, systems, and/or media or to delineate the scope of the methods, systems, and media. It conceptually identifies the methods, systems, and media in a simplified form as a prelude to the more detailed description that is presented later.

An exemplary method for processing a request for real estate title certification may comprise the steps of: receiving a request for a title certification or title commitment via a mortgage application processing system; performing a title examination; issuing a title commitment separately from a corresponding title policy; responsive to issuing a title commitment, automatically updating the mortgage application processing system to reflect receipt of the title commitment; and creating and delivering a title policy.

An exemplary mortgage application processing system may comprise: a plurality of modules with which a user may request that various loan application steps be performed, including one or more required loan application steps before closing documents may be executed; a status module that provides a pre-funding pipeline of a mortgage application processing system showing the status of pre-conditions to funding the loan, the pre-funding pipeline having a portion corresponding to title commitment for the loan; and a title certification module that: (a) provides a title certification request interface with which a user may request title certification or title commitment; (b) receives a title commitment; and (c) responsive to receiving the title commitment, automatically updates the mortgage application processing system to reflect receipt of the title commitment, including changing a status of the title commitment portion of the pre-funding pipeline to reflect receipt of the title commitment; and a funding module that permits funds for the loan to be requested when the pre-funding pipeline indicates that pre-conditions to funding the loan have been completed, even if a title policy has not been received.

An exemplary method for obtaining title certification for a real estate loan may comprise the steps of: providing a pre-funding pipeline of a mortgage application processing system showing the status of pre-conditions to funding the loan, the pre-funding pipeline having a portion corresponding to title commitment for the loan; providing a title certification request interface with which a user may request title certification or title commitment; receiving a title commitment; responsive to receiving the title commitment, automatically updating the mortgage application processing system to reflect receipt of the title commitment, including changing a status of the title commitment portion of the pre-funding pipeline to reflect receipt of the title commitment; and permitting funds for the loan to be requested when the pre-funding pipeline indicates that pre-conditions to funding the loan have been completed.

Certain illustrative aspects of the methods and systems are described herein in connection with the following description and the annexed drawings. These aspects are indicative, however, of but a few of the various ways in which the principles of the methods, apparatus, systems, and media may be employed and thus the examples are intended to include such aspects and equivalents. Other advantages and novel features may become apparent from the following detailed description when considered in conjunction with the drawings.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1 is a block diagram illustrating a process flow of an exemplary mortgage application processing environment, in accordance with the systems and methods described in the present application; and

FIG. 2 is a flow chart illustrating an exemplary methodology for processing requests for title certification.

### DETAILED DESCRIPTION

Exemplary methods and systems are now described with reference to the drawings, where like reference numerals are used to refer to like elements throughout. In the following description, for purposes of explanation, numerous specific details are set forth in order to facilitate understanding of the methods and systems. It may be evident, however, that the methods and systems can be practiced without these specific details. In other instances, well-known structures and devices are shown in block diagram form in order to simplify the description.

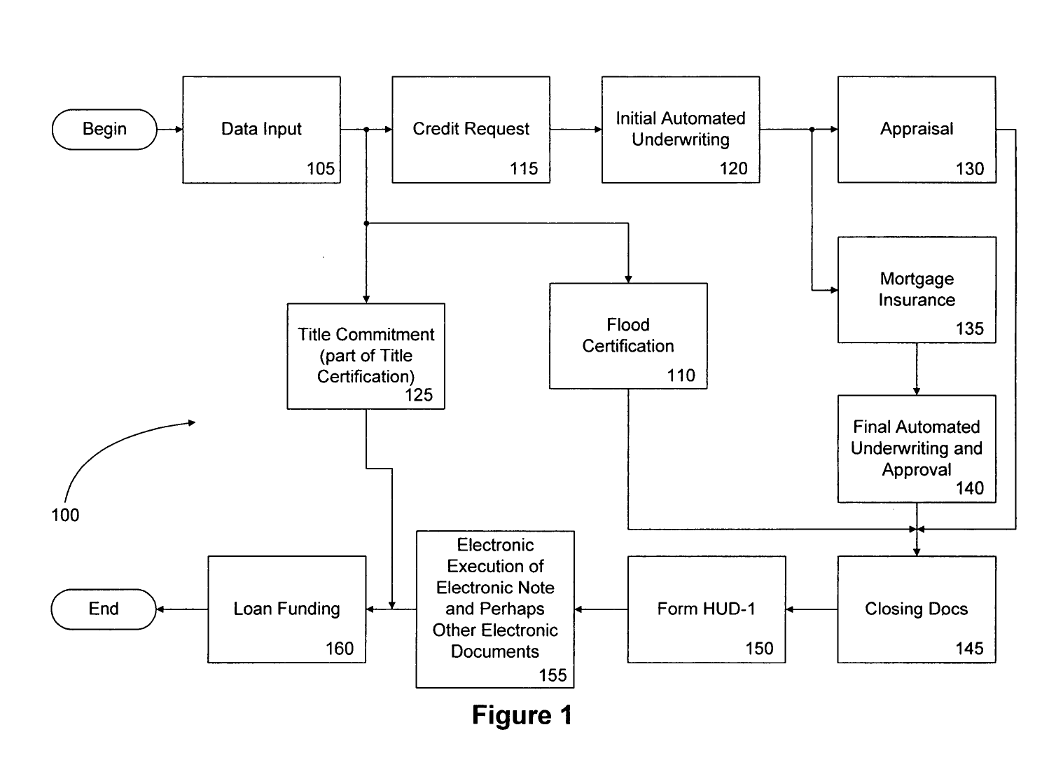

Referring to FIG. 1, a schematic block diagram illustrates an exemplary mortgage application process flow 100 implemented within a mortgage application processing environment. The exemplary mortgage application process flow 100 includes a plurality of interconnected modules that communicate and/or cooperate with each other to process a mortgage application. In one example, the process flow may be implemented on a host computer system executing a mortgage application processing system and communicating with one or more client computers using web pages over the Internet with some users (such as residential mortgage loan brokers or correspondents) using web page browsers. The mortgage application processing system may be hosted by or on behalf of an entity that may be a lender or another entity administrating the mortgage application processing system or otherwise overseeing the mortgage application process, e.g., an investor or the intended purchaser of a table-funded loan and, as such, the intended assignee of the Note and mortgage.

In the illustrated example, basic data about the transaction (e.g., borrower data, requested loan data, and property data) is input to the mortgage loan application processing system at block 105. The data input block 105 may include collecting or importing information to be used on a borrower information form such as an industry standard 1003 Loan Application Form. Additionally, a loan correspondent or broker may add additional registration information for the loan at block 105 via an input screen of the mortgage application processing system. The data input block 105 may include selecting a specific loan product and also selecting specific vendors for the loan application, such as an underwriter, a closing agent, an appraisal provider or a credit agency, for example, who will assist or perform certain functions during the loan application process. Each time a user enters or changes Form 1003 data or other registration data, and each time data from an entrusted source is overlaid over earlier data, a product eligibility rules engine automatically compares the new set of loan data against a plurality of rules to ensure that the new data set for this loan meets requirements for the currently-selected loan product. If the current loan data set does not meet requirements for the currently-selected loan product, a warning is presented to the user.

At block 110, an electronic flood certification is requested with a flood certification module that provides an electronic interface with a flood certification vendor. The request may be initiated by the loan correspondent or broker via an input screen of the mortgage loan application processing system. In an exemplary embodiment, the electronic flood certification request is transmitted by the mortgage loan application processing system to a computer system at a pre-approved, entrusted flood certification vendor and a flood certification determination made and the results transmitted back (manually or automatically) to the mortgage loan application processing system for access by users. The results of the flood certification may be received at any time during the loan application process until closing documents are generated, at block 145.

In parallel with a request for flood certification at block 110, other functions may be performed. Block 115 is a credit request module which provides an electronic interface with a variety of credit report service providers, such as those available via the Fannie Mae network, for example. The request for borrower credit information may be initiated by the correspondent or broker via an input screen of the mortgage application processing system. In an exemplary embodiment, the electronic credit information request is transmitted by the mortgage application processing system to a computer system at a pre-approved, entrusted credit reporting vendor and borrower credit information is transmitted back (manually or automatically) to the mortgage application processing system for access by system users. The credit request module 115 may include control logic to validate loan registration. In addition, module 115 may include control logic to populate the liabilities portion of the Form 1003 information and control logic to overwrite and/or lock a borrower's credit score upon receiving the credit score from a trusted source.

At block 120, the mortgage application processing system submits a request for initial automated underwriting (“AU”) from a financial service provider. The request for AU findings may be initiated by the loan correspondent or broker via an input screen of the mortgage application processing system and may occur one or more times during the processing of the application as data is changed and new information is entered into the system. According to industry standards, before an AU request may be processed, credit information must be requested for all of the borrowers named on the application (or a user may supply temporary, hypothetical credit score information for the borrower(s) for initial registration purposes). In an exemplary embodiment, the electronic AU submission is transmitted by the mortgage application processing system to a computer system at a pre-approved, entrusted AU vendor (e.g., Fannie Mae's “DU” automated underwriting findings engine) and interim AU findings are transmitted back (manually or automatically) to the mortgage application processing system for access by system users. Upon receiving the interim AU findings from the financial service provider, the mortgage application system parses the findings in a unique manner based on the specific loan to provide the user with approval requirements and documentation requirements tailored to that specific loan.

In the exemplary embodiment, AU findings (either interim or final or both) received from an AU service provider may be processed with a credit rules engine that, among other things, may generate expanded AU findings, which expanded AU findings may include explanations of the significance of certain AU findings; descriptions of specific action(s) a loan correspondent or broker is expected to take in response to certain AU finding(s) thus creating a template for the loan correspondent or broker to self-validate the AU findings; and identification of various options available on the mortgage application processing system (such as the option to electronically execute an electronic Note and/or electronically execute other electronic closing documents and whether loan findings may be self-validated with either Delegated or Almost-Delegated underwriting authority, as discussed herein). Additionally, the exemplary credit rules engine may replace certain AU findings under certain circumstances, such as (i) ignoring certain AU findings that do not apply to the selected loan product and providing substitute AU findings that are appropriate for the selected loan product for the loan data set and (ii) completely ignoring all external AU findings and instead relying on an internal AU engine to generate all AU findings. The exemplary credit rules engine recognizes specific AU findings from the vendor that do not apply to the loan data set, applies its own set of rules to the loan data set, and generates its own replacement AU findings. For example, under certain circumstances the Fannie Mae “DU” AU engine does not provide a helpful loan approval finding, but does provide other helpful information, e.g., for “Jumbo fixed rate” loans and for second mortgage loans, such as HELOC loans. In the case of “Jumbo fixed rate” loans, the Fannie Mae “DU” engine provides many helpful AU findings, but the loan approval finding will never be an “approval” finding. In that case, the exemplary credit rules engine recognizes that the loan approval finding from the vendor does not apply to the loan data set, applies its own set of rules to the loan data set and, if the loan data set complies with the various credit rules engine rules and other applicable rules, will ignore the unfavorable loan approval finding from Fannie Mae and will replace it with an “Approve” AU finding because it is correct in that case for that loan data set. Thus, in that case, the AU findings presented to the user comprise AU findings in part generated by (or expanded from) the external AU vendor and in part generated by (or expanded from) the exemplary credit rues engine.

Block 120 may include associated control logic to permit or block a user from changing some Form 1003 information or registration information based on an AU status level such as “interim” or “final.” In the exemplary embodiment, after final AU findings have been received, the user may only view Form 1003 information and registration information and may not change such data. Further, the financial product/program guidelines may be overlaid or taken into consideration with the AU submission. Block 120 may also have control logic to support features that enhance the quality control of the mortgage application process. For example, the AU module may allow for “expanded approval,” overriding pricing and/or editable data. As another example, block 120 may employ independent verification to obtain F-scores from Form 1003 and registration data (e.g., from Interthinx) to help verify the reasonableness of the requested loan amount. As further examples, block 120 may employ quality control “QC” flags built-in to identify potential fraud or error (e.g., by comparing F-scores to threshold values), and may include control logic which is designed to prevent the loan amount from varying, thereby requiring that the loan amount be approved or denied, but not altered.

As known to those skilled in the art, the title certification process may include several steps, which may include a title examination, issuance of a title commitment (i.e., issuance of a title insurance commitment), and issuance of a separate title policy (i.e., issuance of a title insurance policy). The mortgage application processing system may facilitate this title certification process. Accordingly, at block 125, the exemplary mortgage application processing system may perform one or more steps associated with the title certification process, such as requesting and receiving an electronic title commitment from an entrusted source. Various aspects of electronic title certification may be performed by an external processor, such as using an online web site, for example, or it may be integrated within the mortgage application processing system. Title certification may not be needed for certain applications. That said, in an exemplary embodiment, if title certification (or title commitment) is requested via the mortgage application processing system, a title commitment must be received before the pre-funding pipeline will show that funding is permitted. In this case, the title commitment step 125 may be initiated any time after data registration (block 105) and completed (title commitment received) any time before loan funding (block 160).

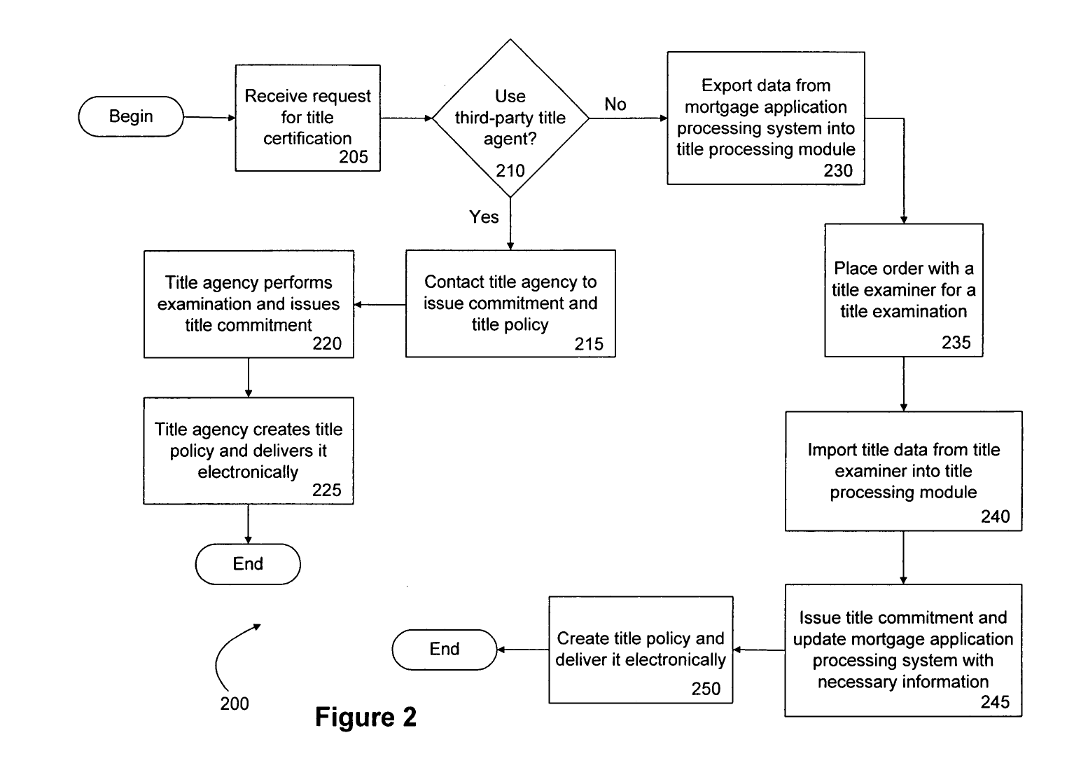

In one exemplary embodiment, a user sends a request for title certification (or title commitment) via the mortgage loan application processing system to a trusted third party service provider, which processes the request (manually or automatically), makes a title certification determination (or title commitment determination), and returns the determination to the mortgage loan application processing system (perhaps in the form of a title commitment, as discussed in the text accompanying FIG. 2), which automatically adds that data to the loan data set. In another exemplary embodiment, a title agency (not necessarily a title insurer), builds and publishes a web site which offers a title commitment (as compared with title insurance). The web site is designed to be used by a loan correspondent or title agent to request a title certification (or title commitment) and in response a title commitment may be issued. The user inputs a loan number and licensing requirements, and the request for title certification may be sent via e-mail. In addition, the identity of the contact, which may include name, telephone number and/or e-mail address, is verified, the title agency is selected and the request goes into its queue. When the title agent sends a confirmation of the request, an industry standard SOFTPRO text file may be generated.

At block 130, optionally appraisal information may be processed via the mortgage loan application processing system. An appraisal may be obtained outside the mortgage loan application processing system and appraisal data manually entered into the system (e.g., any one or more of the following—appraisal type, appraised value, appraisal company, appraisal name, year built, number of bedrooms, and/or monthly rent unit 1—may be manually entered into the system). In the alternative, an appraisal request may be sent by the system to, and a response received by the system from, a trusted third party for processing. In one exemplary embodiment in which an appraisal request is sent by the system to, and a response received by the system from, a trusted third party for processing, the amount of the requested appraisal is determined based on an appraisal type that is at least as reliable as the appraisal type (full, drive-by, etc.) determined by Fannie Mae. In that exemplary embodiment, the property type and appraisal is disabled upon receiving and accepting appraisal. The exemplary embodiment enables a client (e.g., loan correspondent or broker) to accept the appraisal or reject the appraisal and re-submit with comments explaining the rejection. The exemplary embodiment captures client comments, tracks declined appraisal requests and tracks rejected appraisals. Further, the exemplary embodiment extracts certain data elements from PDF documents and verifies the data before submitting the data to the mortgage application processing system.

At block 135, a request for private mortgage insurance is submitted if necessary to support the mortgage application. In the exemplary embodiment, private mortgage insurance is requested for loans in which the loan-to-value ratio is greater than 80%. The private mortgage insurance is requested electronically according to an industry-standard data set as defined by the Mortgage Insurance Standards Maintenance Organization (“MISMO”). In the exemplary embodiment, a number of features are supported including the ability to lock or block certain fields, such as the private Mortgage Insurance company or the coverage percentage, for example. Other features supported by the exemplary embodiment include the editing, disabling and/or matching of certain fields, the ability to approve or suspend the private mortgage insurance, the ability to treat the private mortgage insurance certification provider as a trusted third party, and the ability to electronically extract and save mortgage insurance certification data, even though the mortgage insurance certification per se is not actually received by the system.

At block 140, once the private mortgage insurance has been requested, as necessary, at block 135 and the flood certification has been obtained at block 110, the mortgage application processing system obtains final underwriting approval (and other final AU findings) from the AU (in the same manner as discussed above in connection with initial AU findings at block 120). In one exemplary embodiment, approval of AU findings may be received using a proprietary data exchange with the mortgage insurance company.

Block 140 may also include certain other steps to obtain loan approval which are completed prior to requesting that closing documents be generated by the mortgage application processing system. In an exemplary embodiment, certain findings from final AU must be validated as a condition to approve the loan. The exemplary embodiment may permit loans to be approved according to at least four scenarios:
(1) approval authority delegated directly from the lender to a trusted, qualified correspondent or broker, or from the lender to an underwriter who in turn delegates approval authority to a trusted, qualified correspondent or broker;
(2) approval authority delegated from the lender to an underwriter associated with a correspondent or broker (who may be an employee of the correspondent or broker or who may be an in-house representative of an underwriting company such as MGIC, Radian, UG, or PMI);
(3) approval authority delegated from the lender to a contract underwriter; and
(4) the lender (mortgage bank) reserves approval authority.
   This exemplary methodology for approving loans with the exemplary mortgage application processing system is discussed in greater detail in U.S. Patent Application Ser. No. 60/737,019 entitled SYSTEM AND METHOD FOR SELF-VALIDATION OF REAL ESTATE LOAN FINDINGS and filed herewith on Nov. 15, 2005 (attorney docket 30728/04005), the complete disclosure of which is hereby incorporated herein by reference.

Once the loan has been approved, the client has the ability to request that closing documents be generated, at block 145. In the exemplary embodiment, closing documents may be executed as either paper documents or as a combination of paper and electronic documents. Perhaps, eventually, all closing documents may be executed as electronic documents. In the exemplary mortgage loan application processing system embodiments, paper closing documents may be generated by sending data (e.g., XML data) corresponding to the transaction to a service provider (e.g., Digital Docs) that generates a closing document package that is communicated to transaction participants (e.g., by sending a link to a PDF file having an image of the closing paper documents). As to electronic documents, a service provider (e.g., Digital Docs) may be used to generate an all-electronic document closing package with an electronic Note and other electronic closing documents in any of various electronic formats (e.g., in XML format or any of the MISMO SMARTDoc formats) or may be used to generate a hybrid electronic/paper closing package with some documents (such as an electronic Note) in any of various electronic formats (e.g., in XML format) and other documents in any of various formats for execution on paper (e.g., by sending a link to a PDF file having an image of the closing paper documents). Thereafter, electronic execution of the electronic Note and perhaps other electronic closing documents may be implemented with an electronic document execution processing module 155, described in greater detail below. Otherwise, the borrower(s) execute any paper documents.

At block 150, if necessary or requested, a form HUD-1 may be prepared, executed by the borrower(s), and transmitted to personnel administrating the mortgage application processing system, e.g., faxed or couriered to those personnel. Those personnel may be, for example, personnel of the lender or personnel of another entity administrating the mortgage application processing system or otherwise overseeing the mortgage application process, e.g., the intended purchaser of a table-funded loan and, as such, the intended assignee of the Note and mortgage. The receipt of an executed form HUD-1 may be entered into the mortgage application processing system for tracking of pre-funding conditions and perhaps also display in a status display such as a pre-funding pipeline. The form HUD-1 may be prepared manually. In the alternative, a HUD processing module portion of the mortgage application processing system may be executed to calculate the contents of form HUD-1 and provide a completed form HUD-1 for execution. In the alternative, a form HUD-1 may be prepared by a different computer system.

At block 155, closing documents are executed as either paper documents, electronic documents, or a combination of paper and electronic documents. As discussed above, in an exemplary embodiment, an electronic document execution processing module enables mortgage application processing system electronic documents to be executed, secured and stored. The exemplary electronic document execution process dynamically displays the status of the closing. In one exemplary embodiment, rows and columns represent borrowers and activities, respectively, including, for example, dynamic display of each borrower's consent to electronically signing the electronic Note and perhaps other electronic closing documents and dynamic display of each borrower's electronic execution of the electronic Note and other electronic closing documents, if any.

In an exemplary embodiment, an electronic document execution processing module accepts the following input:
An Electronic Consent, and
An electronic Note
   The exemplary electronic document execution processing module may also accept closing agent certification that documents were electronically signed and/or borrower identity verification.

The exemplary electronic document execution module may be operated by a closing agent who is logged in to the mortgage application processing system and leads each borrower through the signing process. During the signing process, the closing agent may verify each borrower's identity, for example by running a match against an ID number in a database. For example, this may include verifying the driver's license of the borrower. The closing agent may also cause the system to display a consent document displayed with a user interface element, such as an “I Consent” button or the like. The borrower/executor may evidence consent by actuating the user interface element, such as by selecting “I Consent” (e.g., by clicking the “I Consent” button). The consent action may be date/time stamped and preserved as proof of borrower's/executor's consent to use the electronic document execution process. At this point in the electronic execution process, or at some other point in the process, the borrower/executor may be requested to acknowledge the format of the electronic signature, which may be applied to the consent form, the electronic Note, and any other electronic documents. For example, the consent form with the electronic execution therein may be displayed with a user interface element, such as an “I accept” button or the like. The borrower/executor may accept the electronic signature by actuating the user interface element, such as by selecting “I accept” (e.g., by clicking the “I accept” button). The closing agent next may cause the system to display the electronic Note, formatted as a “SmartDoc” in certain embodiments, which the borrower may electronically execute by actuating a user interface element, such as by selecting “Sign” (e.g., by clicking a “Sign” button). Again, the acceptance action may be date/time stamped and preserved as proof of acceptance.

The closing agent finally may acknowledge/affirm that the consent and the electronic Note have been completely and properly executed, e.g., by actuating a user interface element, such as a “Submit” button, and the electronic Note is thereby registered on an e-registry, such as the “Mortgage Electronic Registry System®” (“MERS®”) registry, for example. MERS is a company formed by the U.S. mortgage industry to create a standard registry system for eNotes. The MERS® data set in the MERS® registry identifies the location and owner of a note. The electronic document execution processing module also digitally secures and tamper-seals the note, and other documents as appropriate, in accordance with standards defined by MISMO.

At block 160, the loan funding module is executed and the loan is funded. In an exemplary embodiment, a matrix referred to as a pre-funding pipeline is employed to show the status of all pre-conditions to funding the loan. One example of a pre-condition to funding a loan is loan approval, which in some cases means validation that final AU findings have been examined and are acceptable and all requirements in final AU findings have been complied with. In addition, generation of closing documents, whether paper documents or a combination of paper and electronic documents, may be identified as necessary or unnecessary based on the information in the loan account. In an exemplary embodiment, neither paper nor electronic documents must be executed prior to loan funding. In the alternative, electronic execution of some or all of the electronically executable documents for the transaction by some or all of the borrowers/executors with an electronic document execution module for execution of an electronic Nota and/or other electronic closing documents may be another pre-condition to requesting funding for a loan. In any case, funding may occur when the preconditions are complete (as may be indicated in the pipeline). Once the pipeline is complete, the closing agent or client may order funds. The funds may be transferred automatically using wire transfers. As used herein, funding activity described as being done “automatically” or characterized as “automatic” or “automated” is intended to mean funding activity that does not require any manual checking that any pre-funding requirements are unmet prior to funding. For example, there may be some manual activity involved with wire transfers, but this does not keep the funding activity from being “automatic” as used herein. Thus, the fact that wire transfer instructions might be conveyed via diskette from a mortgage application processing system computer to a computer in an associated wire transfer department responding to user-requested automatic funding of a loan in accordance with the present invention does not keep the wire transfer and funding from being “automatic” in the sense being used herein. As discussed in more detail below, to facilitate rapid funding when paper documents are executed at block 155, the funding module may be executed without any electronic confirmation (or fax confirmation) that the papers were actually executed by the borrower(s). In the alternative, a loan correspondent or broker may be required to confirm via the mortgage application processing system that documents have been executed before funding is available. Thus, some common delays typically associated with loan funding (e.g., time to prepare and transmit and analysis of funding “requests” and the faxing of pre-funding documents to the lender or to another entity administrating the mortgage application processing system or otherwise overseeing the mortgage application process, e.g., the intended purchaser of a table-funded loan and, as such, the intended assignee of the Note and mortgage) are avoided and correspondents and brokers have more control over the timing of loan funding. This exemplary methodology for funding loans with the exemplary mortgage application processing system is discussed in greater detail in U.S. Patent Application Ser. No. 60/737,014 entitled SYSTEM AND METHOD FOR AUTOMATED FUNDING OF REAL ESTATE MORTGAGE TRANSACTIONS and filed herewith on Nov. 15, 2005 (attorney docket 30728/04004), the complete disclosure of which is hereby incorporated herein by reference.

After all the paper and/or electronic documents have been executed, the borrower(s) may be provided with a copy of the paper documents and a printout of any electronically executed documents. The closing agent may be instructed by the lender (or by another entity administrating the mortgage application processing system or otherwise overseeing the mortgage application process, e.g., the intended purchaser of a table-funded loan and, as such, the intended assignee of the Note and mortgage) in tailored closing instructions for the loan to provide the borrowers with such copies. Finally, any executed paper closing documents generated by closing documents module 145 may be sent to the lender (or to another entity administrating the mortgage application processing system or otherwise overseeing the mortgage application process, e.g., the intended purchaser of a table-funded loan and, as such, the intended assignee of the Note and mortgage) (perhaps along with a printout of some or all of the electronically executed documents) for confirmation of execution, audit, etc. by the lender (or by the other entity).

Referring now to FIG. 2, there is a flowchart illustrating an exemplary methodology 200 for processing requests for title certification. Methodology 200 represents the processing steps executed by exemplary title commitment block 125 shown in FIG. 1, and also includes additional steps (i.e., steps 225 and 250) directed toward creation and issuance of a title policy. A title certification request interface may include a status portion showing the status of a title certification request. The status portion of the title certification request interface may indicate that a title agent has confirmed the title certification request, may indicate that a title agent has declined the title certification request, may indicate that a title agent has issued a title commitment. The status portion of the title certification request interface may indicate that a title agent has confirmed the title certification request and later indicate that a title agent has issued a title commitment.

By way of example, the exemplary methodology 200 will be described from the perspective of a title company associated with the mortgage bank employing the mortgage application processing system of FIG. 1, although the methodology may be employed easily by other entities. At block 205, a request for title certification is received at a title processing system. Title personnel may confirm or decline the request for title certification (or title commitment), which may be communicated via a status display. If the request is declined, no further processing in FIG. 2 takes place. If the request is confirmed, the title processing system then determines whether a third-party title agent has been identified to provide the title policy, at 210. If a third-party is to be used, processing flow is directed to block 215.

At block 215, the appropriate title agent is contacted to issue a commitment and a title policy. In one embodiment, the contact is made via e-mail, although other forms of contact are contemplated by the present invention. At block 220, the title agent performs the title examination and issues the title commitment. The title commitment may be communicated directly to the mortgage application processing system. If the title commitment is sent by mail or by fax or by e-mail or the like, the mortgage application processing system data for that application may need to be manually updated (e.g., application pipeline data set) to reflect receipt of the title commitment to permit funding. After issuing the title commitment, the title agency creates a title policy and delivers it to the mortgage applicant and/or to the mortgage bank, completing the title certification process, as shown by block 225.

In the event that a third party title agent is not being used, process flow is directed to block 230. At block 230, data exported from the mortgage application processing system is imported into the title processing module. Based on the imported information, an order is placed with a title examiner for a title examination as shown by block 235. An interface is provided with which the title examiner may confirm or decline the request for title. Upon completion of the title examination, title data is imported into the title processing module from the title examiner's system. At block 240, a title commitment is then issued electronically and the mortgage application processing system is updated automatically to reflect the receipt of the title commitment. To complete the title certification processing, a title policy is created and delivered to the mortgage applicant and/or to the mortgage bank.

It should be noted that the mortgage application processing system employs the title commitment to complete the mortgage application process (to permit funding), while delivery of the title policy, which completes the title certification process, may take place some time after the mortgage closes.

FIG. 2 illustrates an exemplary methodology 200 for processing requests for title certification. In the alternative, the method of FIG. 2 may be modified slightly to process a request for title commitment, in which case issuance of a title commitment and updating of the mortgage application processing system (blocks 220 and 245) may complete this method (as this permits loan funding), and block 225 or block 250 (as applicable) may perhaps be performed as part of a separate request for issuance of a title insurance policy.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Moreover, the steps of the methods described and claimed in the present application may be preformed in any suitable order. Therefore, the invention in its broader aspects is not limited to the specific details, representative apparatus and methods, and illustrative examples shown and described. Accordingly, departures may be made from such details without departing from the spirit or scope of the applicant's general inventive concept. Such improvements, changes and modifications within the skill of the art are intended to be covered by the present application.

What is claimed is:

1. A method for obtaining title certification for a real estate loan, comprising the steps of:
providing a pre-funding pipeline of a mortgage application processing system showing the status of pre-conditions to funding the loan, the pre-funding pipeline having a portion corresponding to title commitment for the loan;
providing a title certification request interface with which a user may request title certification or title commitment;
receiving a title commitment;
responsive to receiving the title commitment, automatically updating the mortgage application processing system to reflect receipt of the title commitment, including changing a status of the title commitment portion of the pre-funding pipeline to reflect receipt of the title commitment; and
permitting funds for the loan to be requested when the pre-funding pipeline indicates that pre-conditions to funding the loan have been completed.

2. The method of claim 1 wherein the title certification request interface includes a status portion showing the status of a request for title certification or title commitment.

3. The method of claim 2 wherein the status portion of the title certification request interface indicates whether a title agent has confirmed the request for title certification or title commitment.

4. The method of claim 2 wherein the status portion of the title certification request interface indicates whether a title agent has declined the request for title certification or title commitment.

5. The method of claim 2 wherein the status portion of the title certification request interface indicates that a title agent has issued a title commitment.

6. The method of claim 2 wherein the status portion of the title certification request interface indicates that a title agent has confirmed the request for title certification or title commitment and later indicates that a title agent has issued a title commitment.

7. A method for processing a request for real estate title certification, comprising the steps of:
receiving a request for a title certification or title commitment via a mortgage application processing system;
performing a title examination;
issuing a title commitment separately from a corresponding title policy;
responsive to issuing a title commitment, automatically updating the mortgage application processing system to reflect receipt of the title commitment; and
creating and delivering a title policy.

8. The method of claim 7 wherein a title commitment is issued by a third-party title agent and communicated directly to the mortgage application processing system.

9. The method of claim 8 wherein the title policy is created and delivered electronically.

10. The method of claim 7 further comprising the step of exporting data from the mortgage application processing system to a title processing module responsive to a determination that a third party title agent is not to be used for the request for title certification or title commitment.

11. The method of claim 7 wherein the title policy is created and delivered electronically.

12. The method of claim 7 wherein the title policy may be delivered after the mortgage closes.

13. The method of claim 7 wherein the mortgage application processing system further comprises a pre-funding pipeline the showing the status of pre-conditions to funding a loan, the pre-funding pipeline having a portion corresponding to title commitment for the loan; and wherein the step of automatically updating the mortgage application processing system to reflect receipt of the title commitment includes changing a status of the title commitment portion of the pre-funding pipeline to reflect receipt of the title commitment to facilitate funding of the loan before a title policy is delivered.

14. An Internet-based mortgage application processing system, comprising:
a plurality of modules with which a user may request that various loan application steps be performed, including one or more required loan application steps before closing documents may be executed;
a status module that provides a pre-funding pipeline of a mortgage application processing system showing the status of pre-conditions to funding the loan, the pre-funding pipeline having a portion corresponding to title commitment for the loan; and
a title certification module that:
provides a title certification request interface with which a user may request title certification or title commitment;
receives a title commitment; and
responsive to receiving the title commitment, automatically updates the mortgage application processing system to reflect receipt of the title commitment, including changing a status of the title commitment portion of the pre-funding pipeline to reflect receipt of the title commitment; and
a funding module that permits funds for the loan to be requested when the pre-funding pipeline indicates that pre-conditions to funding the loan have been completed, even if a title policy has not been received.

15. The method of claim 14 wherein the title certification request interface includes a status portion showing the status of a request for title certification or title commitment.

16. The method of claim 14 wherein the status portion of the title certification request interface indicates whether a title agent has confirmed the request for title certification or title commitment.

17. The method of claim 14 wherein the status portion of the title certification request interface indicates whether a title agent has declined the request for title certification or title commitment.

18. The method of claim 14 wherein the status portion of the title certification request interface indicates that a title agent has issued a title commitment.

19. The method of claim 14 wherein the status portion of the title certification request interface indicates that a title agent has confirmed the request for title certification or title commitment and later indicates that a title agent has issued a title commitment.
